(19) United States
(12) Patent Application Publication
(10) Pub. No.: US 2016/0313531 A1
(43) Pub. Date: Oct. 27, 2016

(54) LENS DEVICE, POSITIONING PAD AND IMAGE CAPTURING DEVICE THEREOF

(71) Applicant: VIVOTEK INC., New Taipei City (TW)

(72) Inventor: Hsiang-Lin Hsu, New Taipei City (TW)

(21) Appl. No.: 15/132,254

(22) Filed: Apr. 19, 2016

(30) Foreign Application Priority Data
Apr. 21, 2015 (TW) 104112728

(51) Int. Cl. G02B 7/02; H04N 5/225

(52) U.S. Cl. CPC G02B 7/023; H04N 5/2253; H04N 5/2254

(57) ABSTRACT

A lens device includes a circuit board, a lens module, a sensor for receiving images captured by the lens module, and a positioning pad. The lens module has an optical axis. The sensor is disposed on the circuit board and has a central axis and first and second reference surfaces perpendicular to each other. The positioning pad is disposed on the lens module and has a hollow structure for containing the sensor. The hollow structure has first and second abutting sides and first and second biasing elastic arms. The first and second biasing elastic arms are opposite to the first and second abutting sides respectively for biasing the sensor to a position where the first and second reference surfaces abut against the first and second abutting sides respectively when the sensor is contained in the hollow structure, so as to make the central axis aligned with the optical axis.

### BACKGROUND OF THE INVENTION

1. Field of the Invention

The present invention relates to a lens device, a positioning pad and an image capturing device thereof, and more specifically, to a lens device utilizing a hollow structure of a positioning pad to position a sensor on a lens module, a positioning pad and an image capturing device thereof.

2. Description of the Prior Art

In general, a conventional image capturing device (e.g. an image surveillance apparatus) utilizes a lens module to focus captured images on a sensor (e.g. Charge Couple Device (CCD) or Complementary Semiconductor Sensor (CMOS)) for completing an image capturing process. Thus, during the aforesaid image capturing process, whether the lens module is aligned with the sensor has great influence on the image capturing quality of the image capturing device.

However, since the lens module is usually assembled with the sensor by directly welding the sensor to a circuit board and then engaging positioning holes on the circuit board with positioning pillars of the lens module for mounting the circuit board on the lens module, it may cause misalignment between a central axis of the sensor and an optical axis of the lens module due to welding errors of the aforesaid welding process as well as poor positioning accuracy between the positioning holes on the circuit board and the positioning pillars of the lens module since the circuit board is difficult to machine, so as to influence the image capturing quality of the image capturing device. This problem needs to be solved by a complicated manual/automatic calibration process, so as to make assembly of the lens module and the sensor strenuous and time-consuming.

### SUMMARY OF THE INVENTION

The present invention provides a lens device including a circuit board, a lens module, a sensor, and a positioning pad. The lens module has an optical axis for capturing images. The sensor is disposed on the circuit board and has a central axis, a first reference surface, and a second reference surface. The first reference surface is perpendicular to the second reference surface. The sensor is used for receiving the images captured by the lens module. The positioning pad is disposed on the lens module and has a hollow structure for containing the sensor. The hollow structure has a first abutting side, a second abutting side, a first biasing elastic arm, and a second biasing elastic arm. The first biasing elastic arm and the second biasing elastic arm are opposite to the first abutting side and the second abutting side respectively for biasing the sensor to a position where the first reference surface and the second reference surface abut against the first abutting side and the second abutting side respectively when the sensor is contained in the hollow structure, so as to make the central axis aligned with the optical axis.

The present invention further provides a positioning pad including a hollow structure for positioning a sensor. The sensor has a first reference surface and a second reference surface. The first reference surface is perpendicular to the second reference surface. The hollow structure has a first abutting side, a second abutting side, a first biasing elastic arm, and a second biasing elastic arm. The hollow structure is used for containing the sensor. The first biasing elastic arm and the second biasing elastic arm are opposite to the first abutting side and the second abutting side respectively for biasing the sensor to a position where the first reference surface and the second reference surface abut against the first abutting side and the second abutting side respectively for fixing the sensor when the sensor is contained in the hollow structure.

The present invention further provides an image capturing device including a lens device and a control module. The lens device includes a circuit board, a lens module, a sensor, and a positioning pad. The lens module has an optical axis for capturing images. The sensor is disposed on the circuit board and has a central axis, a first reference surface, and a second reference surface. The first reference surface is perpendicular to the second reference surface. The sensor is used for receiving the images captured by the lens module. The positioning pad is disposed on the lens module and has a hollow structure for containing the sensor. The hollow structure has a first abutting side, a second abutting side, a first biasing elastic arm, and a second biasing elastic arm. The first biasing elastic arm and the second biasing elastic arm are opposite to the first abutting side and the second abutting side respectively for biasing the sensor to a position where the first reference surface and the second reference surface abut against the first abutting side and the second abutting side respectively when the sensor is contained in the hollow structure, so as to make the central axis aligned with the optical axis. The control module is coupled to the sensor for controlling the sensor to capture the images.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of an image capturing device according to an embodiment of the present invention.

FIG. 2 is a diagram of a lens device in FIG. 1.

FIG. 3 is an exploded diagram of the lens device in FIG. 2.

FIG. 4 is an assembly diagram of a positioning pad in FIG. 2 being disposed on a lens module.

FIG. 5 is a bottom view of a sensor being contained in a hollow structure of the positioning pad in FIG. 4 disposed on the lens module.

FIG. 6 is a bottom view of a lens device according to another embodiment of the present invention.

### DETAILED DESCRIPTION

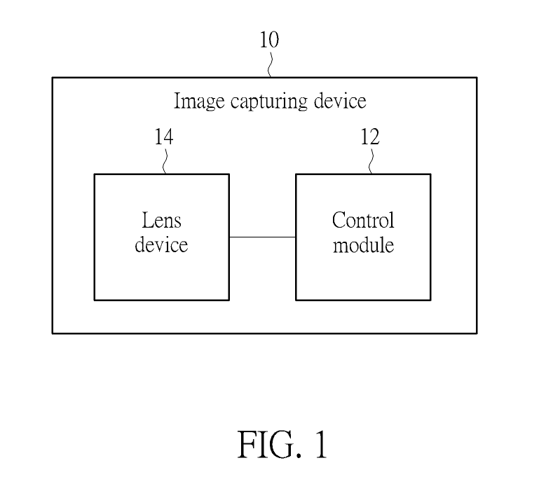

Please refer to FIG. 1, which is a functional block diagram of an image capturing device 10 according to an embodiment of the present invention. The image capturing device 10 could be preferably an image surveillance apparatus (but not limited thereto). As shown in FIG. 1, the image capturing device 10 includes a control module 12 and a lens device 14. The control module 12 is coupled to the lens device 14 for controlling the lens device 14 to capture images. As for the related description for the controlling design of the control module 12, it is known in the prior art and omitted herein.

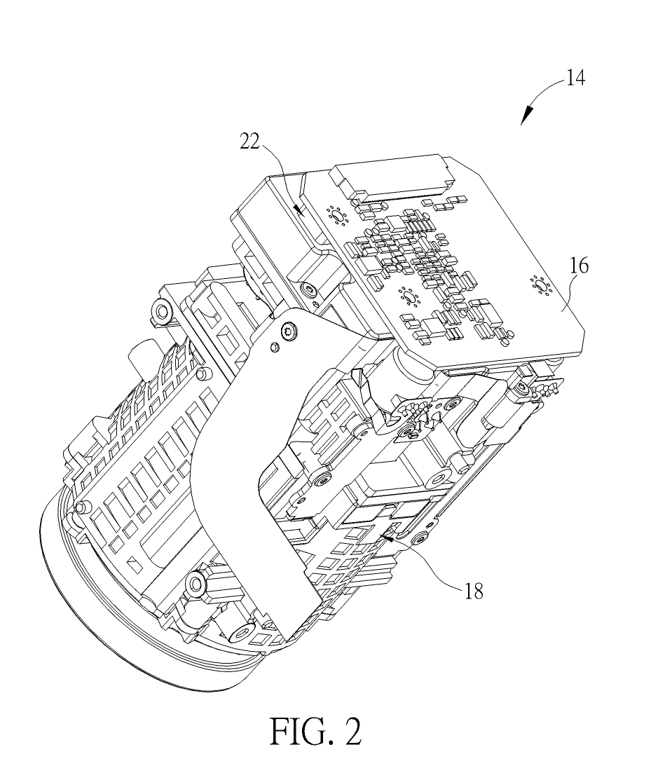

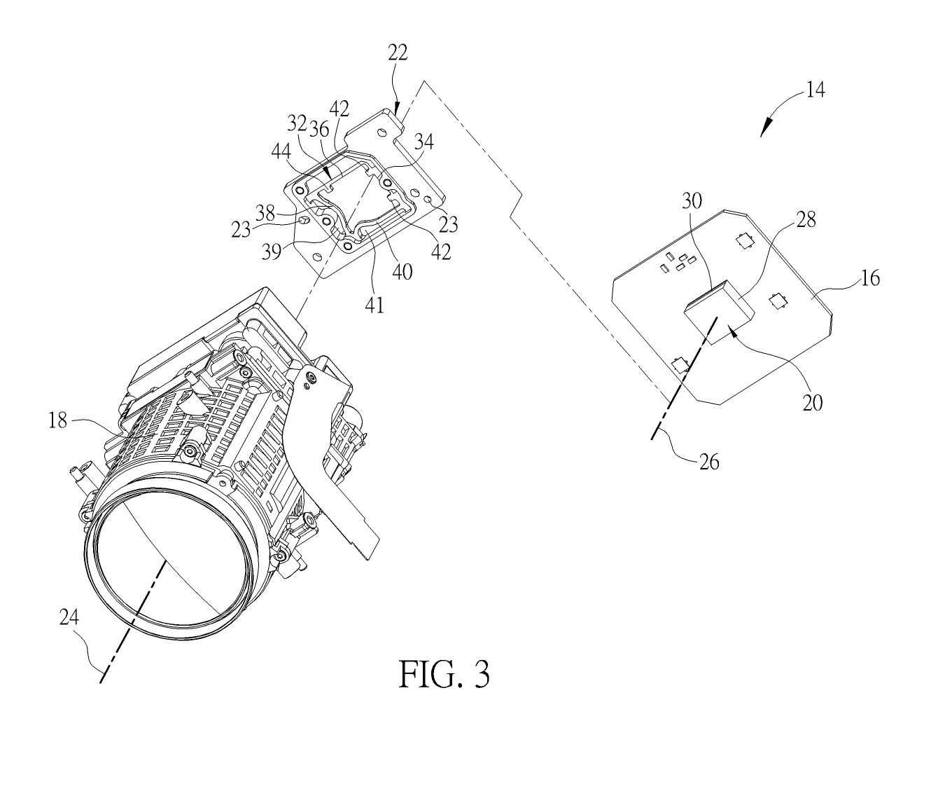

More detailed description for the structural design of the lens device 14 is provided as follows. Please refer to FIG. 2 and FIG. 3. FIG. 2 is a diagram of the lens device 14 in FIG. 1. FIG. 3 is an exploded diagram of the lens device 14 in FIG. 2. As shown in FIG. 2 and FIG. 3, the lens device 14 includes a circuit board 16, a lens module 18, a sensor 20, and a positioning pad 22. The lens module 18 could be a lens assembly commonly applied to image capturing of an image surveillance apparatus (but not limited thereto), and has an optical axis 24. The lens module 18 is used for capturing images. The sensor 20 could be a conventional image sensor (e.g. CCD or CMOS) for receiving the images captured by the lens module 18. The sensor 20 is disposed on the circuit board 16 and has a central axis 26, a first reference surface 28, and a second reference surface 30. The first reference surface 28 and the second reference surface 30 could be perpendicular to each other (but not limited thereto) as positioning reference surfaces for assembly of the lens module 18 and the sensor 20. The positioning pad 22 is disposed on the lens module 18 and has a hollow structure 32 for containing the sensor 20. The hollow structure 32 could have a first abutting side 34, a second abutting side 36, a first biasing elastic arm 38, and a second biasing elastic arm 40. The first biasing elastic arm 38 and the second biasing elastic arm 40 are opposite to the first abutting side 34 and the second abutting side 36 respectively. To be more specific, in this embodiment, as shown in FIG. 3, at least one first protruding point 42 (two shown in FIG. 3, but not limited thereto) extends inwardly from the first abutting side 34, and at least one second protruding point 44 (one shown in FIG. 3, but not limited thereto) extends inwardly from the second abutting side 36. The second protruding point 44 could be preferably formed on the second abutting side 36 close to the first biasing elastic arm 38, but not limited thereto. Via the aforesaid structural design, when the sensor 20 is contained in the hollow structure 32, the first biasing elastic arm 38 could bias the sensor 20 to a position where the first reference surface 28 abuts against the first protruding points 42 of the first abutting side 34 in a point-to-face contact manner, and the second biasing elastic arm 40 could bias the sensor 20 to a position where the second reference surface 30 abuts against the second protruding point 44 of the second abutting side 36 in a point-to-face contact manner, so as to generate the biaxial positioning effect.

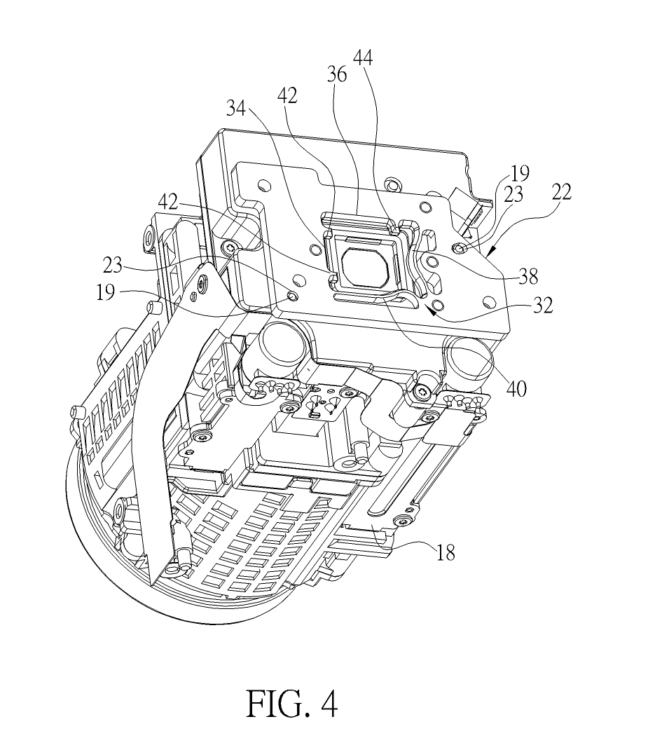

To be noted, in practical application, the hollow structure 32 could have a slot hole 39 formed thereon corresponding to the first biasing elastic arm 38 and a slot hole 41 formed thereon corresponding to the second biasing elastic arm 40, so as to improve the structural elasticity of the first biasing elastic arm 38 and the second biasing elastic arm 40. Furthermore, in this embodiment, the positioning pad 22 could be detachably disposed on the lens module 18 in a shaft-hole fitting manner. For example, please refer to FIG. 4, which is an assembly diagram of the positioning pad 22 in FIG. 2 being disposed on the lens module 18. As shown in FIG. 4, at least two positioning holes 23 (two shown in FIG. 4, but not limited thereto) could be formed on the positioning pad 22, and the lens module 18 could have positioning pillars 19 formed thereon corresponding to the positioning holes 23. Accordingly, since the positioning pad 22 (e.g. a pad structure formed by an injection molding process) is an independent member from the circuit board 16 for solving the prior art problem that the circuit board is difficult to machine to cause poor positioning accuracy between the positioning holes on the circuit board and the positioning pillars of the lens module, it could greatly improve positioning accuracy between the positioning holes 23 formed on the positioning pad 22 and the positioning pillars 19 of the lens module 18. In such a manner, the positioning pad 22 could be positioned on the lens module 18 more precisely. Moreover, for improving the image capturing quality of the image capturing device 10, the image capturing device 10 could adopt the design in which the sensor 20 could be positioned at a focus of the lens module 18 when the sensor 20 disposed on the circuit board 16 is contained in the hollow structure 32 and the positioning pad 22 is sandwiched between the lens module 18 and the circuit board 16 (e.g. the positioning pad 22 could have a specific thickness to separate the circuit board 16 from the lens module 18 at a distance for positioning the sensor 20 at the focus of the lens module 18), so that the sensor 20 could clearly receive the images captured by the lens module 18.

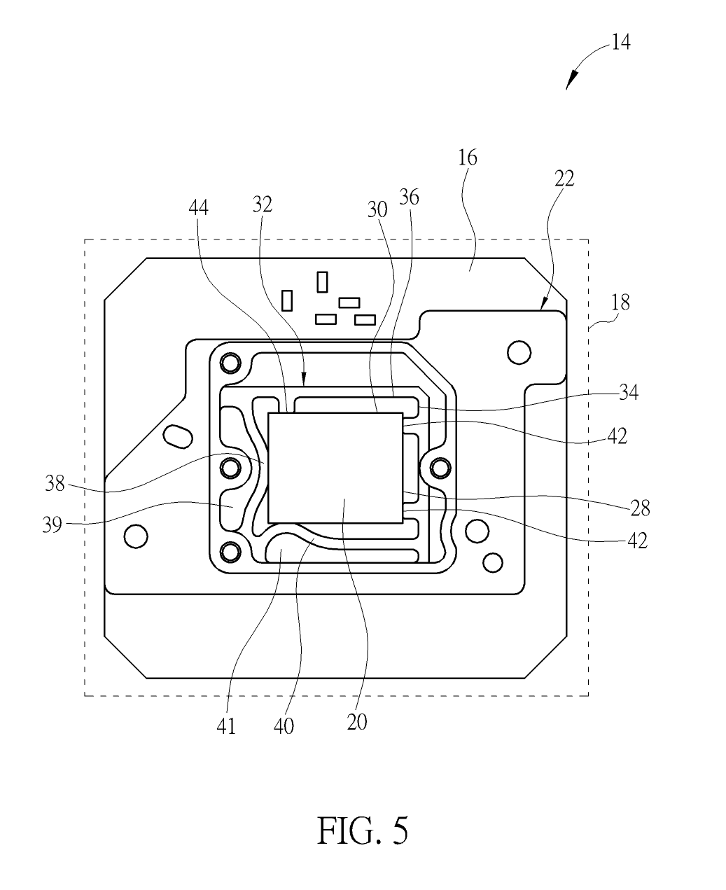

Via the aforesaid design, when a user wants to assemble the positioning pad 22 with the lens module 18 and the sensor 20, the user just needs to align the positioning holes 23 on the positioning pad 22 with the positioning pillars 19 on the lens module 18 and then sleeves the positioning holes 23 on the positioning pillars 19, so that the positioning pad 22 could be positioned on the lens module 18 precisely and steadily (as shown in FIG. 4). Subsequently, the user could place the circuit board 16 on the positioning pad 22 and press the circuit board 16 to make the sensor 20 on the circuit board 16 contained in the hollow structure 32 (as shown in FIG. 5, which is a bottom view of the sensor 20 being contained in the hollow structure 32 of the positioning pad 22 in FIG. 4 disposed on the lens module 18). For clearly showing the structural relationship between the sensor 20 and the hollow structure 32, the lens module 18 is briefly depicted by dotted lines in FIG. 5.

During the aforesaid process, as shown in FIG. 5, when the sensor 20 is contained in the hollow structure 32, the first biasing elastic arm 38 could bias the sensor 20 to a position where the first reference surface 28 abuts against the first protruding points 42 of the first abutting side 34 in a point-to-face contact manner, and the second biasing elastic arm 40 could bias the sensor 20 to a position where the second reference surface 30 abuts against the second protruding point 44 of the second abutting side 36 in a point-to-face contact manner. In such a manner, via the aforesaid positioning design in which the sensor 20 could take the first reference surface 28 and the second reference surface 30 as two positioning reference surfaces for abutting against the first abutting side 34 and the second abutting side 36 of the hollow structure 32 respectively, the central axis 26 of the sensor 20 could be aligned with the optical axis 24 of the lens module 18 precisely. On this condition, the control module 12 could control the sensor 20 to capture the images clearly so as to greatly improve the image capturing quality of the image capturing device 10. To be noted, the central axis 26 and the optical axis 24 are two virtual axes and therefore invisible to the human eyes.

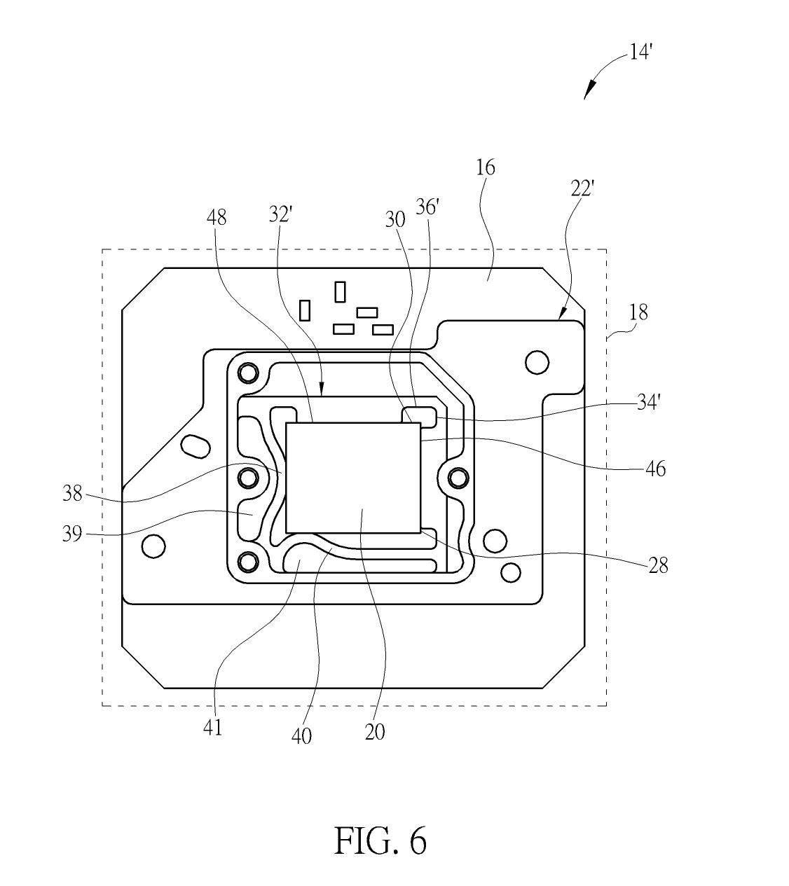

It should be mentioned that the abutting design for positioning the sensor is not limited to the aforesaid embodiment. For example, please refer to FIG. 3 and FIG. 6. FIG. 6 is a bottom view of a lens device 14′ according to another embodiment of the present invention. Components both mentioned in this embodiment and the aforesaid embodiment represent components with similar functions or structures, and the related description is omitted herein. As shown in FIG. 6, the lens device 14′ includes the circuit board 16, the lens module 18, the sensor 20, and a positioning pad 22′. The positioning pad 22′ is disposed on the lens module 18 and a hollow structure 32′ for containing the sensor 20. The hollow structure 32′ could have a first abutting side 34′, a second abutting side 36′, the first biasing elastic arm 38, and the second biasing elastic arm 40. In this embodiment, the first abutting side 34′ could have a first planar surface 46, and the second abutting side 36′ could have a second planar surface 48. Accordingly, when the sensor 20 is contained in the hollow structure 32′, the first biasing elastic arm 38 could bias the sensor 20 to a position where the first reference surface 28 abuts against the first planar surface 46 of the first abutting side 34′ in a face-to-face contact manner, and the second biasing elastic arm 40 could bias the sensor 20 to a position where the second reference surface 30 abuts against the second planar surface 48 of the second abutting side 36′ in a face-to-face contact manner, so that the central axis 26 of the sensor 20 could be aligned with the optical axis 24 of the lens module 18 precisely.

As for the related description for other derived embodiments, it could be reasoned by analogy according to the aforesaid embodiments. That is, all the designs, in which a sensor is contained in a hollow structure of a positioning pad and the positioning pad utilizes its biasing elastic arms to bias the sensor to a position where reference surfaces of the sensor abut against abutting sides of the hollow structure for biaxial positioning of the sensor, could fall within the scope of the present invention. For example, in another embodiment, the image capturing device of the present invention could adopt the design in which the first and second biasing elastic arms of the positioning pad bias the sensor to a positioning where the first reference surface abuts against the planar surface of the first abutting side of the hollow structure in a face-to-face contact manner and the second reference surface abuts against the protruding point of the second abutting side of the hollow structure in a point-to-face contact manner, to achieve the purpose that the central axis of the sensor could be aligned with the optical axis of the lens module. As for which design is utilized, it depends on the practical application of the image capturing device of the present invention.

Furthermore, as known from the aforesaid description and as shown in FIG. 4, the present invention could utilize the positioning pads with different sizes for different types of sensors since the positioning pad 22 could be detachably disposed on the lens module 18. Moreover, in another embodiment, the present invention could adopt the design in which the positioning pad is integrally formed with the lens module for simplifying the assembly process of the image capturing device.

Compared with the prior art, the present invention adopts the design in which the sensor is contained in the hollow structure of the positioning pad and the positioning pad utilizes the biasing elastic arms to bias the sensor to a position where the reference surfaces of the sensor abut against the abutting sides of the hollow structure for biaxial positioning of the sensor, to ensure that the central axis of the sensor could be aligned with the optical axis of the lens module precisely. In such a manner, the present invention could efficiently solve the prior art problem that the central axis of the sensor is misaligned with the optical axis of the lens module due to welding errors between the sensor and the circuit board and poor positioning accuracy between the circuit board and the lens module, so as to omit the complicated manual/automatic calibration process and greatly improve the image capturing quality of the image capturing device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A lens device comprising:
a circuit board;
a lens module having an optical axis for capturing images;
a sensor disposed on the circuit board and having a central axis, a first reference surface, and a second reference surface, the first reference surface being perpendicular to the second reference surface, the sensor being used for receiving the images captured by the lens module; and
a positioning pad disposed on the lens module and having a hollow structure for containing the sensor, the hollow structure having a first abutting side, a second abutting side, a first biasing elastic arm, and a second biasing elastic arm, the first biasing elastic arm and the second biasing elastic arm being opposite to the first abutting side and the second abutting side respectively for biasing the sensor to a position where the first reference surface and the second reference surface abut against the first abutting side and the second abutting side respectively when the sensor is contained in the hollow structure, so as to make the central axis aligned with the optical axis.

2. The lens device of claim 1, wherein at least one first protruding point extends inwardly from the first abutting side, and the first biasing elastic arm biases the sensor to a position where the first reference surface abuts against the at least one first protruding point of the first abutting side in a point-to-face contact manner when the sensor is contained in the hollow structure.

3. The lens device of claim 2, wherein at least one second protruding point extends inwardly from the second abutting side, and the second biasing elastic arm biases the sensor to a position where the second reference surface abuts against the at least one second protruding point of the second abutting side in a point-to-face contact manner when the sensor is contained in the hollow structure.

4. The lens device of claim 3, wherein the at least one second protruding point is formed on the second abutting side close to the first biasing elastic arm.

5. The lens device of claim 1, wherein the first abutting side has a first planar surface, and the first biasing elastic arm biases the sensor to a position where the first reference surface abuts against the first planar surface of the first abutting side in a face-to-face contact manner when the sensor is contained in the hollow structure.

6. The lens device of claim 5, wherein at least one protruding point extends inwardly from the second abutting side, and the second biasing elastic arm biases the sensor to a position where the second reference surface abuts against the at least one protruding point of the second abutting side in a point-to-face contact manner when the sensor is contained in the hollow structure.

7. The lens device of claim 6, wherein the at least one protruding point is formed on the second abutting side close to the first biasing elastic arm.

8. The lens device of claim 5, wherein the second abutting side has a second planar surface, and the second biasing elastic arm biases the sensor to a position where the second reference surface abuts against the second protruding point of the second abutting side in a face-to-face contact manner when the sensor is contained in the hollow structure.

9. The lens device of claim 1, wherein the positioning pad is detachably disposed on the lens module in a shaft-hole fitting manner.

10. The lens device of claim 1, wherein the positioning pad is integrally formed with the lens module.

11. The lens device of claim 1, wherein the sensor disposed on the circuit board is contained in the hollow structure and the positioning pad is sandwiched between the lens module and the circuit board for positioning the sensor at a focus of the lens module.

12. A positioning pad for positioning a sensor, the sensor having a first reference surface and a second reference surface, the first reference surface being perpendicular to the second reference surface, the positioning pad comprising:
a hollow structure having a first abutting side, a second abutting side, a first biasing elastic arm, and a second biasing elastic arm, the hollow structure being used for containing the sensor, the first biasing elastic arm and the second biasing elastic arm being opposite to the first abutting side and the second abutting side respectively for biasing the sensor to a position where the first reference surface and the second reference surface abut against the first abutting side and the second abutting side respectively for fixing the sensor when the sensor is contained in the hollow structure.

13. An image capturing device comprising:
a lens device comprising:
a circuit board;
a lens module having an optical axis for capturing images;
a sensor disposed on the circuit board and having a central axis, a first reference surface, and a second reference surface, the first reference surface being perpendicular to the second reference surface, the sensor being used for receiving the images captured by the lens module; and
a positioning pad disposed on the lens module and having a hollow structure for containing the sensor, the hollow structure having a first abutting side, a second abutting side, a first biasing elastic arm, and a second biasing elastic arm, the first biasing elastic arm and the second biasing elastic arm being opposite to the first abutting side and the second abutting side respectively for biasing the sensor to a position where the first reference surface and the second reference surface abut against the first abutting side and the second abutting side respectively when the sensor is contained in the hollow structure, so as to make the central axis aligned with the optical axis; and
a control module coupled to the sensor for controlling the sensor to capture the images.

14. The image capturing device of claim 13, wherein at least one first protruding point extends inwardly from the first abutting side, and the first biasing elastic arm biases the sensor to a position where the first reference surface abuts against the at least one first protruding point of the first abutting side in a point-to-face contact manner when the sensor is contained in the hollow structure.

15. The image capturing device of claim 14, wherein at least one second protruding point extends inwardly from the second abutting side, and the second biasing elastic arm biases the sensor to a position where the second reference surface abuts against the at least one second protruding point of the second abutting side in a point-to-face contact manner when the sensor is contained in the hollow structure.

16. The image capturing device of claim 15, wherein the at least one second protruding point is formed on the second abutting side close to the first biasing elastic arm.

17. The image capturing device of claim 13, wherein the first abutting side has a first planar surface, and the first biasing elastic arm biases the sensor to a position where the first reference surface abuts against the first planar surface of the first abutting side in a face-to-face contact manner when the sensor is contained in the hollow structure.

18. The image capturing device of claim 17, wherein at least one protruding point extends inwardly from the second abutting side, and the second biasing elastic arm biases the sensor to a position where the second reference surface abuts against the at least one protruding point of the second abutting side in a point-to-face contact manner when the sensor is contained in the hollow structure.

19. The image capturing device of claim 17, wherein the second abutting side has a second planar surface, and the second biasing elastic arm biases the sensor to a position where the second reference surface abuts against the second protruding point of the second abutting side in a face-to-face contact manner when the sensor is contained in the hollow structure.

20. The image capturing device of claim 13, wherein the sensor disposed on the circuit board is contained in the hollow structure and the positioning pad is sandwiched between the lens module and the circuit board for positioning the sensor at a focus of the lens module.
